(19) United States
(12) Patent Application Publication
(10) Pub. No.: US 2026/0223912 A1
(43) Pub. Date: Aug. 6, 2026

(54) DEVICE AND METHOD FOR WEAKENING A SHEET OF AEROSOL-GENERATING SUBSTRATE FOR AN AEROSOL-GENERATING ARTICLE COMPONENT

(71) Applicant: Philip Morris Products S.A., Neuchatel (CH)

(72) Inventor: Stefano ZAPPOLI, Milano (IT)

(73) Assignee: Philip Morris Products S.A., Neuchatel (CH)

(21) Appl. No.: 19/150,571

(22) PCT Filed: Jan. 22, 2024
(86) PCT No.: PCT/EP2024/051401

§ 371 Date: Jul. 24, 2025

(30) Foreign Application Priority Data
Jan. 31, 2023 (EP) 23154112

(51) Int. Cl. A24C 5/18; A24B 15/14; B26F 1/20

(52) U.S. Cl. CPC A24C 5/1828; A24B 15/14; B26F 1/20

(57) ABSTRACT

A device for weakening a sheet of aerosol-generating substrate for an aerosol-generating article component is provided, the device including: first and second rollers having respective first and second rotation axes and respective first and second circumferential ridges provided on their respective first and second radial outer faces, the first and the second ridges delimiting respective first and second circumferential grooves on the respective first and second outer faces, each first ridge including relief recesses circumferentially spaced from each other along the first ridge, elevations being delimited between the relief recesses, in which, at a coupling zone of the first and the second rollers, the elevations of the first ridges are inserted in the second grooves, and in which, in a respective cross section including the first and the second rotation axes, each first and each second circumferential ridge has a rectangular outline.

The present disclosure relates to a device and a method for weakening a sheet of aerosol-generating substrate for an aerosol-generating article component.

Aerosol-generating articles or heat-not-burn cigarettes in which an aerosol-generating substrate is heated rather than combusted, are known in the art. The aerosol-generating substrate is, for instance, a tobacco-free herbaceous or plant-based cast sheet or a plastic fiber-based material or a biodegradable fiber-based material. Typically in such heated aerosol-generating articles, an aerosol is generated by the transfer of heat from a heat source to a physically separate aerosol-generating substrate or material, which may be located in contact with, within, around, or downstream of the heat source. During use of the aerosol-generating article, volatile compounds are released from the aerosol-generating substrate by heat transfer from the heat source and are entrained in air drawn through the aerosol-generating article. As the released compounds cool, they condense to form an aerosol.

In a typical manufacturing process of aerosol generating articles, an aerosol-generating substrate in a sheet or foil format goes through a crimping process. The crimped material is then gathered into a rod which is cut into parts. These cut rods are components of the aerosol generating articles.

The crimping process generally uses two rotating cylindrical rollers between which the sheet of material is pressed. These rollers have matching textured ridge-and-trough patterns on their outside surfaces that crimp the sheet through transversal stretching of substrate's fibers.

The crimping process is helpful for folding and gathering the sheet of aerosol-generating substrate into the rods that will fit into the aerosol generating articles. Indeed, the term “crimped sheet” denotes a sheet having a plurality of substantially parallel ridges or corrugations which are substantially parallel to the cylindrical axis of the rod. This facilitates folding and gathering of the crimped sheet of aerosol-generating substrate to form the rod.

The crimping process also influences, inter alia, the amount of air contact, the Resistance to Draw (RTD), and others, and, hence, is directly experienced by the users of the aerosol generating articles.

For instance, document EP3041375B1 discloses a method and an apparatus of manufacturing variable crimped web material. The web material is crimped using a set of two rollers, each roller being corrugated across at least a portion of its width and corrugated around its circumference, the rollers being configured such that the corrugations across the width of the rollers interleave with each other to crimp the web material and such that the troughs of the corrugations around the circumference crimp the web material at the first crimp value and the peaks of the corrugations around the circumference crimp the web material at the second crimp value.

Document EP3542648A1 discloses a device for producing a strand of web material, comprising a separating device which is set up to separate a flat web of reconditioned tobacco material into a large number of strips. The device comprises a first roller and a second roller, wherein the lateral surfaces of the rollers alternately have, in the axial direction, circumferential grooves and elevations that are closed in the circumferential direction. The elevations of the first roller engage in the grooves of the second roller and the elevations of the second roller engage in the grooves of the first roller. The flat web is not cut along the dividing line by the interaction of two blades, but is torn in a defined manner by overstretching.

Document EP3469922A1 discloses a machine for making rod-shaped smoking articles, comprising: unwinding means for unwinding a web of material for the tobacco industry, first cutting means configured to receive and cut the web so as to create a plurality of longitudinal strips, gathering and conveying means configured to gather and convey the longitudinal strips in order to create a continuous stream.

It would be desirable to have a device and a method for weakening a sheet of aerosol-generating substrate for an aerosol-generating article component providing an alternative way of having crimping effects, i.e. shaping the sheet so as to facilitate folding and gathering of the sheet of aerosol-generating substrate to form a rod.

The present disclosure relates to a device for weakening a sheet of aerosol-generating substrate for an aerosol-generating article component. The device may comprise a first roller having a first rotation axis. The first roller may comprise a plurality of first circumferential ridges provided on a first radial outer face of said first roller, the first circumferential ridges delimiting a respective plurality of first circumferential grooves on the first radial outer face. The device may comprise a second roller having a second rotation axis. The second roller may comprise a plurality of second circumferential ridges provided on a second radial outer face of said second roller, the second circumferential ridges delimiting a respective plurality of second circumferential grooves on the second radial outer face. Each first circumferential ridge may comprise a plurality of relief recesses circumferentially spaced from each other along said first circumferential ridge. A plurality of elevations are delimited between the relief recesses. At a coupling zone of the first roller with the second roller, the elevations of the first circumferential ridges may be inserted in the second circumferential grooves. In a cross section including the first rotation axis, each first circumferential ridge may have a rectangular outline. In a cross section including the second rotation axis, each second circumferential ridge may have a rectangular outline. The rectangular outlines of the first circumferential ridge and of the second circumferential ridge may have sharp edges configured to generate cuts in a sheet of aerosol-generating substrate passing between the first roller and the second roller, said cuts creating weakened folding lines facilitating folding and gathering of said sheet of aerosol-generating substrate to form a rod.

The inventor found that the scissor-type cutting of the invention is an alternative to crimping which avoids transversal stretching of the sheet of aerosol-generating substrate into crimping rollers and prevents or at least reduces shredding effects and dust generation, in particular at high speeds. Indeed, compressing of the sheet in traditional crimping is a critical issue. While a too low crimping pressure may decrease the positive effects of the crimping, a too high pressure could damage the sheet of material or decrease its tensile strength, which in turn may increase tearing occurrence and may even cause shredding.

The inventor found that cutting instead of crimping avoids stretching the fibers of the sheet and prevents or at least decreases dust generation and accumulation due to defibration.

The inventor found that the device according to the invention allows increasing the speed of the sheet of aerosol-generating substrate to be weakened and the productivity of the overall production process, because the speed of the sheet according to the method of the invention is no longer limited by the crimping pressure exerted on said sheet. Indeed, in the traditional crimping method, in order to increase speed and reduce the crimping time, a greater pressure has to be applied to the sheet for assuring a proper crimping, which increases the risk of damaging the sheet, including accidental shredding, during the crimping process.

The inventor found that the sharp edges of the first and second circumferential ridges are capable of generating defined and precise cuts.

The inventor found that the first and second circumferential ridges having the rectangular outline with sharp edges are solid, durable, easy to manufacture and easy to maintain (the edges may be sharpened once in a while) and are able to generate the desired cuts.

This device for weakening may also be suitable for weakening a sheet of material, different from the aerosol-generating substrate, employed in the field of aerosol-generating articles manufacturing, e.g. for making filters or other components of the aerosol-generating articles.

Each of the sharp edges may have an angle (α) of 90 degrees. Each of the sharp edges may have a radius (r1) equal to or less than 0.05 mm. Each of the sharp edges may have a radius (r1) equal to or greater than 0.03. The inventor found that these values of the radius of the sharp edges are capable of generating defined and precise cuts in the sheet of aerosol-generating substrate.

A minimum radial distance (dmin) between a bottom portion of the relief recesses of the first roller and a top portion of the second circumferential ridges of the second roller may be equal to or greater than 0.5 mm. A minimum radial distance (dmin) between a bottom portion of the relief recesses of the first roller and a top portion of the second circumferential ridges of the second roller may be equal to or less than 2 mm. A ratio (dmin/Rmax) of a minimum radial distance (dmin) between a bottom portion of the relief recesses of the first roller and a top portion of the second circumferential ridges of the second roller to a maximum radius (Rmax) of the elevations may be equal to or greater than 0.005. A ratio (dmin/Rmax) of a minimum radial distance (dmin) between a bottom portion of the relief recesses of the first roller and a top portion of the second circumferential ridges of the second roller to a maximum radius (Rmax) of the elevations may be equal to or less than 0.03. The maximum radius (Rmax) may be between 40 mm and 300 mm, optionally between 90 mm and 120 mm. A ratio (dmin/t) of a minimum radial distance (dmin) between a bottom portion of the relief recesses of the first roller and a top portion of the second circumferential ridges of the second roller to a thickness (t) of the sheet of aerosol-generating substrate may be equal to or greater than 1.5. A ratio (dmin/t) of a minimum radial distance (dmin) between a bottom portion of the relief recesses of the first roller and a top portion of the second circumferential ridges of the second roller to a thickness (t) of the sheet of aerosol-generating substrate may be equal to or less than 3.5. At the coupling zone of the first roller with the second roller, the elevations of the first circumferential ridges may be spaced from bottoms of the second circumferential grooves. The inventor found that the minimum radial distance (dmin) and the distance of the elevations of the first circumferential ridges from bottoms of the second circumferential grooves ensure that the sheet of aerosol-generating substrate is not compressed and damaged but only cut at the sharp edges of the rollers (scissor-type cut).

A minimum axial distance (daxial) between a first circumferential ridge of the first roller and an adjacent second circumferential ridge of the second roller may be between 0.02 mm and 0.06 mm. A minimum axial distance (daxial) between a first circumferential ridge of the first roller and an adjacent second circumferential ridge of the second roller may be between 0.03 mm and 0.04 mm. A ratio (daxial/Rmax) of a minimum axial distance (daxial) between a first circumferential ridge of the first roller and an adjacent second circumferential ridge of the second roller to a maximum radius (Rmax) of the elevations may be between 0.0002 and 0.0005. A ratio (daxial/t) of a minimum axial distance (daxial) between a first circumferential ridge of the first roller and an adjacent second circumferential ridge of the second roller to a thickness (t) of the sheet of aerosol-generating substrate may be between 0.2 and 0.3. A thickness (t) of the sheet of aerosol-generating substrate may be between 0.15 mm and 0.35 mm. A width (w) of the sheet of aerosol-generating substrate may be between 80 mm and 180 mm. The inventor found that these values of the minimum axial distance (daxial) prevent compressing the sheet and stretching the fibers.

A pitch (a) of the relief recesses may be between 0.2 mm and 20 mm, optionally between 5.0 mm and 20.0 mm, optionally between 6 mm and 16 mm. An axial width (b) of each first circumferential ridge may be between 1 mm and 15 mm, optionally between 2 mm and 4 mm. An axial width (f) of each first circumferential groove may be between 1 mm and 15 mm, optionally between 2 mm and 4 mm. An axial distance (g) between median lines of adjacent first circumferential ridges may be between 2 mm and 6 mm. A circumferential amplitude (c) of the elevations, i.e. a distance between the two ends of the elevation along the circumference, may be between 0.1 and 8 mm, optionally between 4 and 8 mm, optionally between 2 and 4 mm, optionally between 0.1 and 2.0 mm. A circumferential amplitude (e) of the recesses, i.e. a distance between the two ends of the recess along the circumference, may be between 0.1 and 8 mm, optionally between 2 and 6 mm, optionally between 2 and 4 mm, optionally between 0.1 and 2.0 mm. The inventor found that these values of pitch (a), width (b) and amplitude (c) enable the generation of cuts with features that allow for proper and easy folding of the sheet of aerosol-generating substrate.

Each relief recess may be delimited by a concave surface. The concave surface may be arch-shaped. A radius (r3) of the concave surface may be between 5 mm and 15 mm. The inventor found that the first circumferential ridges provided with the relief recesses having the disclosed shape are easy to manufacture, for instance by milling.

Each concave surface and two respective adjoining elevations may delimit two auxiliary edges parallel to the first rotation axis. Each of the auxiliary edges may be rounded. The inventor found that the rounded auxiliary edges prevent cutting and damaging the sheet along lines transversal to the cuts where the sheet touches said auxiliary edges.

According to an embodiment of the present disclosure, the relief recesses of one first circumferential ridge may be circumferentially offset with respect to the relief recesses of another first circumferential ridge to generate offset cuts. The relief recesses of one first circumferential ridge may be circumferentially offset with respect to the relief recesses of two first circumferential ridges contiguous to the one first circumferential ridge. By moving along the first rotation axis in one direction, the relief recesses of each first circumferential ridge may be circumferentially offset with respect to a preceding first circumferential ridge always in a same direction (clockwise or counter-clockwise). An offset distance (Od) between the relief recesses of two adjacent first circumferential ridges is between 0 mm and 20 mm. The offset distance (Od) may be between 20% and 40% of the circumferential amplitude (c) of the elevations. An angular offset (β) between the relief recesses of two adjacent first circumferential ridges may be between 0 degrees and 30 degrees. The offset of the relief recesses generates offset cuts on the sheet of aerosol-generating substrate and improves cuts distribution homogeneity.

According to an embodiment of the present disclosure, the relief recesses of the first circumferential ridges may be reciprocally aligned along directions parallel to the first rotation axis to generate groups of cuts aligned along directions transversal to a feeding direction of the sheet of aerosol-generating substrate. The top portion of each second circumferential ridge may be continuous and devoid of relief recesses. The inventor found that, if only the first roller is provided with the relief recesses, no phase cooperation between the first and the second roller is required. Indeed, the angular position of the first roller with respect to the second roller about their respective first and second rotation axes does not require to be set at the beginning of the weakening method and needs no adjustment (re-phasing) during operation of the device. This will result in easier manufacturing of the roller assembly and faster set up.

The first roller may have a first axial length (L1) measured parallel to the first rotation axis (X-X) and between the two first circumferential ridges placed at opposite ends of the first roller. The first axial length (L1) may be between 80 percent and 90 percent of the width (w) of the sheet of aerosol-generating substrate. The second roller may have a second axial length (L2) measured parallel to the second rotation axis (Y-Y) and between the two second circumferential ridges placed at opposite ends of the second roller. The second axial length (L2) may be between 80 percent and 90 percent of the width (w) of the sheet of aerosol-generating substrate.

According to an embodiment of the present disclosure, the first roller may comprise a plurality of first disks and a plurality of second disks. The first disks and the second disks may be stacked and arranged in alternating manner. The first disks may comprise the first circumferential ridges. The second disks may define bottoms of the first circumferential grooves. The second roller may comprise a plurality of third disks and a plurality of fourth disks. The third disks and the fourth disks may be stacked and arranged in alternating manner. The third disks may comprise the second circumferential ridges. The fourth disks may define bottoms of the second circumferential grooves. The inventor found that this kind of structure is easy and cheap to manufacture.

The cuts may be through-cuts. The cuts completely pass through the thickness of the sheet of aerosol-generating substrate thus creating weakened segments in the sheet.

The sheet of aerosol-generating substrate may be an herbaceous or plant-based cast sheet. The sheet of aerosol-generating substrate may comprise fibers, vegetable and/or alkaloid particles, a binder and an aerosol forming agent. The vegetable and/or alkaloid particles may comprise tobacco and/or nicotine and/or botanicals and/or cellulose powder. The sheet of aerosol-generating substrate may be tobacco-free or a tobacco-containing substrate. The sheet of aerosol-generating substrate may be a fiber-based material. The fiber-based material may be a plastic fiber-based material or a biodegradable fiber-based material. The biodegradable fiber-based material may be cotton. The biodegradable fiber-based material may be cellulose. The sheet of aerosol-generating substrate may have a thickness comprised between 0.15 and 0.35. The sheet of aerosol-generating substrate may contain an alkaloid. The sheet of aerosol-generating substrate may contain nicotine.

The present disclosure also relates to a method for weakening a sheet of aerosol-generating substrate for an aerosol-generating article component. The method may comprise: making cuts in the sheet of aerosol-generating substrate. The cuts in the sheet may be made by passing the sheet of aerosol-generating substrate between the first roller and the second roller of a device for weakening the sheet of aerosol-generating substrate for an aerosol-generating article component while the first roller and the second roller rotate in opposite directions. Said cuts creating weakened folding lines facilitating folding and gathering of said sheet of aerosol-generating substrate to form a rod. The device may comprise a first roller having a first rotation axis. The first roller may comprise a plurality of first circumferential ridges provided on a first radial outer face of said first roller, the first circumferential ridges delimiting a respective plurality of first circumferential grooves on the first radial outer face. The device may comprise a second roller having a second rotation axis. The second roller may comprise a plurality of second circumferential ridges provided on a second radial outer face of said second roller, the second circumferential ridges delimiting a respective plurality of second circumferential grooves on the second radial outer face. Each first circumferential ridge may comprise a plurality of relief recesses circumferentially spaced from each other along said first circumferential ridge. A plurality of elevations are delimited between the relief recesses. At a coupling zone of the first roller with the second roller, the elevations of the first circumferential ridges may be inserted in the second circumferential grooves. In a cross section including the first rotation axis, each first circumferential ridge may have a rectangular outline. In a cross section including the second rotation axis, each second circumferential ridge may have a rectangular outline. The rectangular outlines of the first circumferential ridge and of the second circumferential ridge may have sharp edges configured to generate cuts in a sheet of aerosol-generating substrate passing between the first roller and the second roller, said cuts creating weakened folding lines facilitating folding and gathering of said sheet of aerosol-generating substrate to form a rod.

The inventor found that the method according to the invention is not subject to roller position adjustment. Indeed, in the traditional crimping method, the distance between ridges and grooves of the two rollers should be adjusted at scheduled time intervals by bringing back the rollers closer together because the pressure exerted between the rollers tends to move said rollers away from each other. In the set up according to the invention, the distance may be standard and no adjustment of distance between rollers is required in order to compensate elongation variability of substrate fibers.

The cuts may be through-cuts.

The sheet of aerosol-generating substrate may comprise fibers, vegetable and/or alkaloid particles, a binder and an aerosol forming agent. The vegetable and/or alkaloid particles may comprise tobacco and/or nicotine and/or botanicals and/or cellulose powder. The sheet of aerosol-generating substrate may be an herbaceous or plant-based cast sheet. The sheet of aerosol-generating substrate may be tobacco-free or a tobacco-containing substrate. The sheet of aerosol-generating substrate may be a fiber-based material. The fiber-based material may be a plastic fiber-based material or a biodegradable fiber-based material. The biodegradable fiber-based material may be cotton. The biodegradable fiber-based material may be cellulose. The sheet of aerosol-generating substrate may have a thickness comprised between 0.15 and 0.35. The sheet of aerosol-generating substrate may contain an alkaloid. The sheet of aerosol-generating substrate may contain nicotine.

The sheet of aerosol-generating substrate may move between the first roller and the second roller with a linear speed between 60 m/s and 500 m/s. The first roller may rotate with a peripheral speed between 60 m/s and 500 m/s. The second roller may rotate with a peripheral speed between 60 m/s and 500 m/s. The inventor found that the invention allows to increase the speed of the sheet between the rollers to the disclosed values and thus to improve productivity of the overall production process.

The present disclosure also relates to a sheet of aerosol-generating substrate for an aerosol-generating article component. The sheet may be obtained through a method for manufacturing an aerosol-generating article component. The method comprises: making cuts in the sheet of aerosol-generating substrate by passing the sheet of aerosol-generating substrate between the first roller and the second roller of a device for weakening a sheet of aerosol-generating substrate for an aerosol-generating article component, while the first roller and the second roller rotate in opposite directions, said cuts creating weakened folding lines facilitating folding and gathering of said sheet of aerosol-generating substrate to form a rod.

The cuts in the sheet may be longitudinal cuts parallel to a feeding direction of the sheet of aerosol-generating substrate. Each cut may be a straight line or a zig-zag line or a wavy line.

Each cut may have a length (c′) between 0.1 and 8 mm, for instance between 4 and 8 mm, for instance between 2 and 4 mm, for instance between 0.1 and 2.0 mm. A longitudinal distance (e′) between successive aligned cuts may be between 0.1 and 8 mm, for instance between 2 and 6 mm, for instance between 2 and 4 mm, for instance between 0.1 and 2.0 mm. A transverse distance (b′) between side-by-side cuts may be between 1 mm and 15 mm, for instance between 2 mm and 4 mm. A pitch (a′) of successive aligned cuts may be between 0.2 mm and 20 mm, optionally between 5.0 mm and 20.0 mm, for instance between 6 mm and 16 mm. An offset longitudinal distance (O′d) between adjacent cuts may be between 0 mm and 20 mm. The offset longitudinal distance (O′d) may be between 20% and 40% of the length (c′) of the cuts.

In some embodiments, the cuts are arranged in pairs and each pair comprises two parallel cuts. A transverse distance (b′) between the two parallel cuts may be between 2 and 4 mm. An axial distance (g′) between median lines of adjacent pairs of cuts may be between 2 mm and 6 mm. A transverse distance (f′) between adjacent pairs of cuts may be between 2 mm and 4 mm. An offset longitudinal distance (O′d) between adjacent pairs of cuts may be between 0 mm and 20 mm. The offset longitudinal distance (O′d) may be between 20% and 40% of the length (c′) of the cuts. If each cut is a zig-zag line or a wavy line, a transverse size (h′) of said cut may be between 0.5 mm and 1.5 mm.

The present disclosure also relates to a process for manufacturing an aerosol-generating article component. The process may comprise: manufacturing a sheet of aerosol-generating substrate. The process may comprise: weakening the sheet of aerosol-generating substrate through a method for weakening a sheet of aerosol-generating substrate for an aerosol-generating article component. The process may comprise: gathering the sheet of aerosol-generating substrate to form a continuous rod. The process may comprise: cutting the continuous rod into a plurality of aerosol-generating article components each having a rod shape. Each aerosol-generating article component may comprise a gathered weakened sheet formed from a cut portion of the weakened sheet of aerosol-generating substrate. The method for weakening a sheet of aerosol-generating substrate for an aerosol-generating article component may comprise: making cuts in the sheet of aerosol-generating substrate. The cuts in the sheet may be made by passing the sheet of aerosol-generating substrate between the first roller and the second roller of a device for weakening the sheet of aerosol-generating substrate for an aerosol-generating article component while the first roller and the second roller rotate in opposite directions. Said cuts creating weakened folding lines facilitating folding and gathering of said sheet of aerosol-generating substrate to form a rod.

The inventor found that the discontinuous and longitudinal cuts on the sheet of aerosol-generating substrate made during the manufacturing process through the device of the invention allow creating weakened folding lines which facilitate folding and gathering of said sheet of aerosol-generating substrate to form a rod.

According to an embodiment of the present disclosure, manufacturing the sheet of aerosol-generating substrate may comprise: preparing a slurry with a powder and a binder; casting the slurry onto a surface to produce the sheet of aerosol-generating substrate.

The present disclosure also relates to an aerosol-generating article comprising at least one aerosol-generating article component made according to a process for manufacturing an aerosol-generating article component. The process may comprise a method for weakening a sheet of aerosol-generating substrate for an aerosol-generating article component. The method for weakening a sheet of aerosol-generating substrate for an aerosol-generating article component may comprise: making cuts in the sheet of aerosol-generating substrate. The cuts in the sheet may be made by passing the sheet of aerosol-generating substrate between the first roller and the second roller of a device for weakening the sheet of aerosol-generating substrate for an aerosol-generating article component while the first roller and the second roller rotate in opposite directions. Said cuts creating weakened folding lines facilitating folding and gathering of said sheet of aerosol-generating substrate to form a rod.

The aerosol-generating article may be a heat-not-burn cigarette. The aerosol-generating article may comprise the aerosol-generating article component and a filter with a mouthpiece end.

The present disclosure also relates to an apparatus for manufacturing aerosol-generating article components comprising a device for weakening a sheet of aerosol-generating substrate for an aerosol-generating article component. The device may comprise a first roller having a first rotation axis. The first roller may comprise a plurality of first circumferential ridges provided on a first radial outer face of said first roller, the first circumferential ridges delimiting a respective plurality of first circumferential grooves on the first radial outer face. The device may comprise a second roller having a second rotation axis. The second roller may comprise a plurality of second circumferential ridges provided on a second radial outer face of said second roller, the second circumferential ridges delimiting a respective plurality of second circumferential grooves on the second radial outer face. Each first circumferential ridge may comprise a plurality of relief recesses circumferentially spaced from each other along said first circumferential ridge. A plurality of elevations are delimited between the relief recesses. At a coupling zone of the first roller with the second roller, the elevations of the first circumferential ridges may be inserted in the second circumferential grooves. In a cross section including the first rotation axis, each first circumferential ridge may have a rectangular outline. In a cross section including the second rotation axis, each second circumferential ridge may have a rectangular outline. The rectangular outlines of the first circumferential ridge and of the second circumferential ridge may have sharp edges configured to generate cuts in a sheet of aerosol-generating substrate passing between the first roller and the second roller. Said cuts creating weakened folding lines facilitating folding and gathering of said sheet of aerosol-generating substrate to form a rod.

The apparatus may comprise an upper lamination roller and lower lamination roller placed upstream or downstream of the device for weakening a sheet of aerosol-generating substrate. The upper lamination roller and lower lamination roller may also be placed upstream and downstream of the device for weakening a sheet of aerosol-generating substrate.

The upper lamination roller and the lower lamination roller may be configured to maintain the constant thickness of the sheet of aerosol-generating substrate. The sheet of aerosol-generating substrate may be calendared either before, during or after the weakening/cutting step to ensure that the thickness of the sheet remains symmetrical after the process and before the gathering and folding step into a consumable.

The apparatus may comprise a reel holder carrying the sheet of aerosol-generating substrate. The device for weakening a sheet of aerosol-generating substrate for an aerosol-generating article component being placed downstream of the reel holder. The apparatus may comprise a folding device placed downstream of the device for weakening a sheet of aerosol-generating substrate and configured to move the sheet from a flat configuration (upstream of the folding device) to a gathered rod-shaped configuration (downstream of the folding device). The folding device may be also configured to wrap a wrapper around the gathered sheet. The folding device may be shaped like a tapered funnel.

As used in the present description, the coupling zone of the first roller with the second roller is the portion of the first roller and of the second roller intermeshing with each other where the first circumferential ridges of the first roller are inserted in the second circumferential grooves of the second roller and the second circumferential ridges of the second roller are inserted in the first circumferential grooves of the first roller.

As used in the present description, “weakening” a sheet means that the sheet, after weakening, still retains its integrity, such that it can be gathered by folding along longitudinal folding lines and is not broken in pieces and/or strips. In other words, the cuts generated in the sheet do not cut said sheet in pieces and/or in strips and the weakened sheet, once gathered in the aerosol-generating article component, is a folded sheet and is not broken in pieces and/or strips.

As used in the present description, the top portions of the first circumferential ridges and the top portions of the second circumferential ridges are radially outermost surfaces of said circumferential ridges, i.e. the surfaces of said circumferential ridges furthest from the respective first or second rotation axis.

As used in the present description, the bottom portion of the relief recesses of the first circumferential ridges are radially innermost surfaces of said first circumferential ridges, i.e. the surfaces of said relief recesses closest to the first rotation axis.

As used in the present description, the bottoms of the first circumferential grooves and the bottoms of the second circumferential grooves are radially innermost surfaces of said circumferential grooves, i.e. the surfaces of said circumferential grooves closest to the respective first or second rotation axis.

As used in the present description, the rectangular outline of the cross section of the first and second circumferential ridges means that said cross section has parallel sides and a top portion delimiting with the parallel sides two right angles.

As used in the present description, the axial distance is a distance measured parallel to the first and second rotation axes.

As used in the present description, the radial distance is a distance measured perpendicular to the first and second rotation axes.

As used in the present description, the term circumferential refers to a circumference centred on the first rotation axis or on the second rotation axis.

As used in the present description, the sharpness of the edges is determined by the edge radius of the edge at its apex.

As used in the present description, the circumferential amplitude means a distance between two points along the circumference.

The invention is defined in the claims. However, below there is provided a non-exhaustive list of non-limiting examples. Any one or more of the features of these examples may be combined with any one or more features of another example, embodiment, or aspect described herein.

EX1. A device for weakening a sheet of aerosol-generating substrate for an aerosol-generating article component, the device comprising: a first roller having a first rotation axis and comprising a plurality of first circumferential ridges provided on a first radial outer face of said first roller, the first circumferential ridges delimiting a respective plurality of first circumferential grooves on the first radial outer face; a second roller having a second rotation axis and comprising a plurality of second circumferential ridges provided on a second radial outer face of said second roller, the second circumferential ridges delimiting a respective plurality of second circumferential grooves on the second radial outer face; wherein each first circumferential ridge comprises a plurality of relief recesses circumferentially spaced from each other along said first circumferential ridge, a plurality of elevations being delimited between the relief recesses; wherein, at a coupling zone of the first roller with the second roller, the elevations of the first circumferential ridges are inserted in the second circumferential grooves; wherein, in a cross section including the first rotation axis, each first circumferential ridge has a rectangular outline; wherein, in a cross section including the second rotation axis, each second circumferential ridge has a rectangular outline; wherein the rectangular outlines of the first circumferential ridge and of the second circumferential ridge have sharp edges configured to generate cuts in a sheet of aerosol-generating substrate passing between the first roller and the second roller, said cuts creating weakened folding lines facilitating folding and gathering of said sheet of aerosol-generating substrate to form a rod.

EX2. A method for weakening a sheet of aerosol-generating substrate for an aerosol-generating article component, the method comprising: making cuts in the sheet of aerosol-generating substrate by passing the sheet of aerosol-generating substrate between the first roller and the second roller of the device according to EX1 while the first roller and the second roller rotate in opposite directions, said cuts creating weakened folding lines facilitating folding and gathering of said sheet of aerosol-generating substrate to form a rod.

EX3. A process for manufacturing an aerosol-generating article component, the process comprising the following steps:
manufacturing a sheet of aerosol-generating substrate;
weakening the sheet of aerosol-generating substrate through the method of EX2;
gathering the sheet of aerosol-generating substrate to form a continuous rod;
cutting the continuous rod into a plurality of aerosol-generating article components each having a rod shape, each aerosol-generating article component comprising a gathered weakened sheet formed from a cut portion of the weakened sheet of aerosol-generating substrate.

EX4. An aerosol-generating article comprising at least one aerosol-generating article component made according to the process of EX3.

EX5. An apparatus for manufacturing aerosol-generating article components comprising the device of EX1.

EX6. The device according to EX1, wherein each of the sharp edges has an angle (α) of 90 degrees.

EX7. The device according to EX1 or EX6, wherein each of the sharp edges has a radius (r1) equal to or less than 0.05 mm.

EX8. The device according to EX7, wherein the radius (r1) of each of the sharp edges is equal to or greater than 0.03 mm.

EX9. The device according to EX1 or to any of EX6 to EX8, wherein a minimum radial distance (dmin) between a bottom portion of the relief recesses of the first roller and a top portion of the second circumferential ridges of the second roller is equal to or greater than 0.5 mm.

EX10. The device according to EX9, wherein the minimum radial distance (dmin) is equal to or less than 2 mm.

EX11. The device according to EX1 or to any of EX6 to EX10, wherein a ratio (dmin/Rmax) of a minimum radial distance (dmin) between a bottom portion of the relief recesses of the first roller and a top portion of the second circumferential ridges of the second roller to a maximum radius (Rmax) of the elevations is equal to or greater than 0.005.

EX12. The device according to EX11, wherein the ratio (dmin/Rmax) of the minimum radial distance (dmin) to the maximum radius (Rmax) is equal to or less than 0.03.

EX13. The device according to EX1 or to any of EX6 to EX11, wherein the maximum radius (Rmax) is between 40 mm and 300 mm, optionally between 90 mm and 120 mm.

EX14. The device according to EX1 or to any of EX6 to EX13, wherein a ratio (dmin/t) of a minimum radial distance (dmin) between a bottom portion of the relief recesses of the first roller and a top portion of the second circumferential ridges of the second roller to a thickness (t) of the sheet of aerosol-generating substrate is equal to or greater than 1.5.

EX15. The device according to EX14, wherein the ratio (dmin/t) of the minimum radial distance (dmin) to the thickness (t) is equal to or less than 3.5.

EX16. The device according to EX1 or to any of EX6 to EX15, wherein, at the coupling zone of the first roller with the second roller, the elevations of the first circumferential ridges are spaced from bottoms of the second circumferential grooves.

EX17. The device according to EX1 or to any of EX6 to EX16, wherein a minimum axial distance (daxial) between a first circumferential ridge of the first roller and an adjacent second circumferential ridge of the second roller is between 0.02 mm and 0.06 mm.

EX18. The device according to EX17, wherein said minimum axial distance (daxial) is between 0.03 mm and 0.04 mm.

EX19. The device according to EX1 or to any of EX6 to EX18, wherein a ratio (daxial/Rmax) of a minimum axial distance (daxial) between a first circumferential ridge of the first roller and an adjacent second circumferential ridge of the second roller to a maximum radius (Rmax) of the elevations is between 0.0002 and 0.0005.

EX20. The device according to EX1 or to any of EX6 to EX19, wherein a ratio (daxial/t) of a minimum axial distance (daxial) between a first circumferential ridge of the first roller and an adjacent second circumferential ridge of the second roller to a thickness (t) of the sheet of aerosol-generating substrate is between 0.2 and 0.3.

EX21. The device according to EX1 or any of EX6 to EX20, wherein a thickness (t) of the sheet of aerosol-generating substrate is between 0.15 mm and 0.35 mm.

EX22. The device according to EX1 or to any of EX6 to EX21, wherein a width (w) of the sheet of aerosol-generating substrate is between 80 mm and 180 mm.

EX23. The device according to EX1 or to any of EX6 to EX22, wherein a pitch (a) of the relief recesses is between 0.2 mm and 20 mm, optionally between 5.0 mm and 20.0 mm, optionally between 6 mm and 16 mm.

EX24. The device according to EX1 or to any of EX6 to EX23, wherein an axial width (b) of each first circumferential ridge is between 1 mm and 15 mm, optionally between 2 mm and 4 mm; and/or wherein an axial width (f) of each first circumferential groove is between 1 mm and 15 mm, optionally between 2 mm and 4 mm; and/or wherein an axial distance (g) between median lines of adjacent first circumferential ridges is between 2 mm and 6 mm.

EX25. The device according to EX1 or to any of EX6 to EX24, wherein a circumferential amplitude (c) of the elevations, i.e. a distance between the two ends of the elevation along the circumference, is between 0.1 and 8 mm, optionally between 4 and 8 mm, optionally between 2 and 4 mm, optionally between 0.1 and 2.0 mm; and/or wherein a circumferential amplitude (e) of the recesses, i.e. a distance between the two ends of the recess along the circumference, is between 0.1 and 8 mm, optionally between 2 and 6 mm, optionally between 2 and 4 mm, optionally between 0.1 and 2.0 mm.

EX26. The device according to EX1 or to any of EX6 to EX25, wherein each relief recess is delimited by a concave surface.

EX27. The device according to EX26, wherein said concave surface is arch-shaped.

EX28. The device according to EX27, wherein a radius (r3) of the concave surface is between 5 mm and 15 mm.

EX29. The device according to EX1 or to any of EX6 to EX28, wherein each concave surface and two respective adjoining elevations delimit two auxiliary edges parallel to the first rotation axis, wherein each of the auxiliary edges is rounded.

EX30. The device according to EX1 or to any of EX6 to EX29, wherein the relief recesses of one first circumferential ridge are circumferentially offset with respect to the relief recesses of another first circumferential ridge to generate offset cuts.

EX31. The device according to EX30, wherein the relief recesses of one first circumferential ridge are circumferentially offset with respect to the relief recesses of two first circumferential ridges contiguous to the one first circumferential ridge.

EX32. The device according to EX31, wherein moving along the first rotation axis in one direction, the relief recesses of each first circumferential ridge are circumferentially offset with respect to a preceding first circumferential ridge always in a same direction (clockwise or counter-clockwise).

EX33. The device according to any of EX30 to EX32, wherein an offset distance (Od) between the relief recesses of two adjacent first circumferential ridges is between 0 mm and 20 mm; and/or wherein the offset distance (Od) is between 20% and 40% of the circumferential amplitude (c) of the elevations.

EX34. The device according to EX1 or to any of EX6 to EX33, wherein an angular offset (β) between the relief recesses of two adjacent first circumferential ridges is between 0 degrees and 30 degrees.

EX35. The device according to EX1 or to any of EX6 to EX29, wherein the relief recesses of the first circumferential ridges are reciprocally aligned along directions parallel to the first rotation axis to generate groups of cuts aligned along directions transversal to a feeding direction of the sheet of aerosol-generating substrate.

EX36. The device according to EX1 or to any of EX6 to EX35, wherein the top portion of each second circumferential ridge is continuous and devoid of relief recesses.

EX37. The device according to EX1 or to any of EX6 to EX36, wherein the first roller has a first axial length (L1) measured parallel to the first rotation axis (X-X) and between the two first circumferential ridges placed at opposite ends of the first roller, wherein the first axial length (L1) is between 80 percent and 90 percent of the width (w) of the sheet of aerosol-generating substrate.

EX38. The device according to EX1 or to any of EX6 to EX37, wherein the second roller has a second axial length (L2) measured parallel to the second rotation axis (Y-Y) and between the two second circumferential ridges placed at opposite ends of the second roller, wherein the second axial length (L2) is between 80 percent and 90 percent of the width (w) of the sheet of aerosol-generating substrate.

EX39. The device according to EX1 or to any of EX6 to EX38, wherein the first roller comprises a plurality of first disks and a plurality of second disks; the first disks and the second disks are stacked and arranged in alternating manner; the first disks comprise the first circumferential ridges; the second disks define bottoms of the first circumferential grooves.

EX40. The device according to EX1 or to any of EX6 to EX39, wherein the second roller comprises a plurality of third disks and a plurality of fourth disks; the third disks and the fourth disks are stacked and arranged in alternating manner; the third disks comprise the second circumferential ridges; the fourth disks define bottoms of the second circumferential grooves.

EX41. The apparatus according to EX5, comprising an upper lamination roller and lower lamination roller placed upstream or downstream of the device for weakening a sheet of aerosol-generating substrate; optionally the upper lamination roller and lower lamination roller are placed upstream and downstream of the device for weakening a sheet of aerosol-generating substrate.

EX42. The device according to EX1 or to any of EX6 to EX40 or the method according to EX2, wherein the cuts are through-cuts.

The cuts completely pass through the thickness of the sheet of aerosol-generating substrate thus creating weakened segments in the sheet.

EX43. The device according to EX1 or to any of EX6 to EX40 or the method according to EX2 or EX42, wherein the sheet of aerosol-generating substrate may comprise fibers, vegetable and/or alkaloid particles, a binder and an aerosol forming agent; optionally the sheet of aerosol-generating substrate is an herbaceous or plant-based cast sheet; optionally the vegetable and/or alkaloid particles comprise tobacco and/or nicotine and/or botanicals and/or cellulose powder.

EX44. The device according to EX43, wherein the sheet of aerosol-generating substrate is tobacco-free or a tobacco-containing substrate.

EX45. The device according to EX1 or to any of EX6 to EX40 or the method according to EX2 or to any of EX42 to EX44, wherein the sheet of aerosol-generating substrate is a fiber-based material.

EX46. The device or the method according to EX45, wherein the fiber-based material is a plastic fiber-based material or a biodegradable fiber-based material.

EX47. The device according EX46, wherein the biodegradable fiber-based material is cotton.

EX48. The device according EX1 or to any of EX6 to EX40 or the method according to EX2 or to any of EX42 to EX47, wherein the biodegradable fiber-based material is cellulose.

EX49. The device according EX1 or to any of EX6 to EX40 or the method according to EX2 or to any of EX42 to EX48, wherein the sheet of aerosol-generating substrate has a thickness comprised between 0.15 and 0.35.

EX50. The device according EX1 or to any of EX6 to EX40 or the method according to EX2 or to any of EX42 to EX49, wherein the sheet of aerosol-generating substrate contains an alkaloid.

EX51. The device according EX1 or to any of EX6 to EX40 or the method according to EX2 or to any of EX42 to EX50, wherein the sheet of aerosol-generating substrate contains nicotine.

EX52. The process according EX3, wherein manufacturing the sheet of aerosol-generating substrate comprises: preparing a slurry with a powder and a binder; casting the slurry onto a surface to produce the sheet of aerosol-generating substrate.

EX53. The method according EX2, wherein the sheet of aerosol-generating substrate moves between the first roller and the second roller with a linear speed between 60 m/s and 500 m/s.

EX54. The method according EX2, wherein the first roller rotates with a peripheral speed between 60 m/s and 500 m/s.

EX55. The method according EX2, wherein the second roller rotates with a peripheral speed between 60 m/s and 500 m/s.

EX56. The article according EX4, wherein said aerosol-generating article is a heat-not-burn cigarette.

EX57. The article according EX4 or EX56, wherein said aerosol-generating article comprises the aerosol-generating article component and a filter with a mouthpiece end.

EX58. A sheet of aerosol-generating substrate for an aerosol-generating article component obtained through the method of EX2 or of any of EX42 to EX51 or EX53 to EX55, wherein the cuts are longitudinal cuts parallel to a feeding direction of the sheet of aerosol-generating substrate; wherein optionally each cut is a straight line or a zig-zag line or a wavy line.

EX59. The sheet according to EX58, wherein each cut has a length (c′) between 0.1 and 8 mm, optionally between 4 and 8 mm, optionally between 2 and 4 mm, optionally between 0.1 and 2.0 mm.

EX60. The sheet according to EX58 or EX59, wherein a longitudinal distance (e′) between successive aligned cuts is between 0.1 and 8 mm, optionally between 2 and 6 mm, optionally between 2 and 4 mm, optionally between 0.1 and 2.0 mm.

EX61. The sheet according to any of EX58 to EX60, wherein a transverse distance (b′) between side-by-side cuts is between 1 mm and 15 mm, optionally between 2 mm and 4 mm.

EX62. The sheet according to any of EX58 to EX61, wherein a pitch (a′) of successive aligned cuts is between 0.2 mm and 20 mm, optionally between 5.0 mm and 20.0 mm, optionally between 6 mm and 16 mm.

EX63. The sheet according to any of EX58 to EX62, wherein an offset longitudinal distance (O′d) between adjacent cuts is between 0 mm and 20 mm; and/or wherein the offset longitudinal distance (O′d) is between 20% and 40% of the length (c′) of the cuts.

EX64. The sheet according to any of EX58 to EX63, wherein the cuts are arranged in pairs, each pair comprising two parallel cuts.

EX65. The sheet according to EX64, wherein a transverse distance (b′) between the two parallel cuts is between 2 and 4 mm.

EX66. The sheet according to EX64 or EX65, wherein an axial distance (g′) between median lines of adjacent pairs of cuts is between 2 mm and 6 mm.

EX67. The sheet according to any of EX64 to EX66, wherein a transverse distance (f′) between adjacent pairs of cuts is between 2 mm and 4 mm.

EX68. The sheet according to any of EX64 to EX67, wherein an offset longitudinal distance (O′d) between adjacent pairs of cuts is between 0 mm and 20 mm; and/or wherein the offset longitudinal distance (O′d) is between 20% and 40% of the length (c′) of the cuts.

EX69. The sheet according to any of EX64 to EX67, wherein, if each cut is a zig-zag line or a wavy line, a transverse size (h′) of said cut is between 0.5 mm and 1.5 mm.

Examples will now be further described with reference to the figures in which:

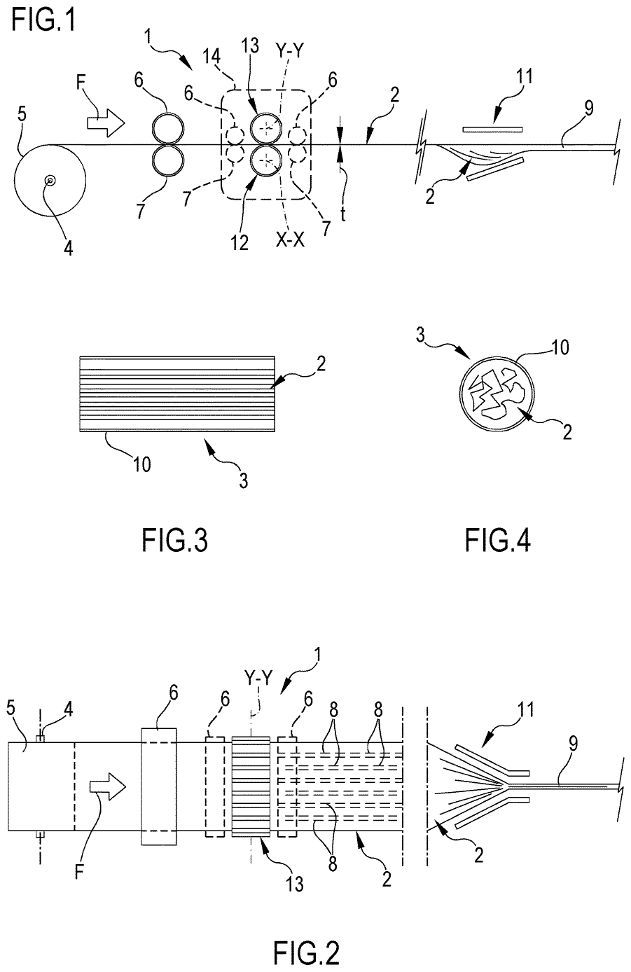

FIG. 1 shows a schematic side view of a portion of an apparatus for manufacturing aerosol-generating article components comprising a device for weakening a sheet of aerosol-generating substrate for an aerosol-generating article component according to the invention;

FIG. 2 shows a top view of the portion of FIG. 1;

FIG. 3 shows a longitudinal section of an aerosol-generating article component manufactured through the apparatus of FIGS. 1 and 2;

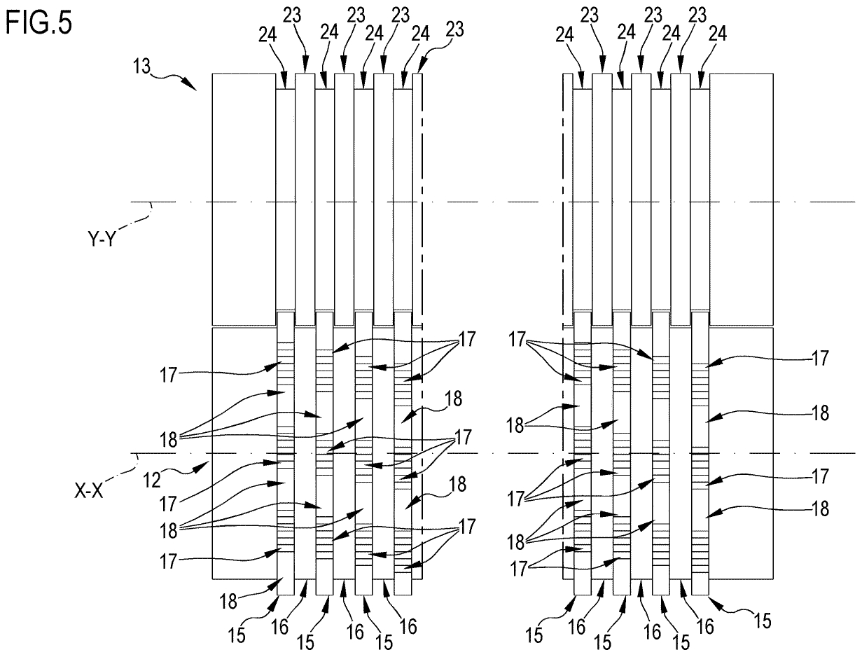

FIG. 4 shows a cross section of the aerosol-generating article component of FIG. 3;

FIG. 5 is a front view of elements of the device of FIGS. 1 and 2;

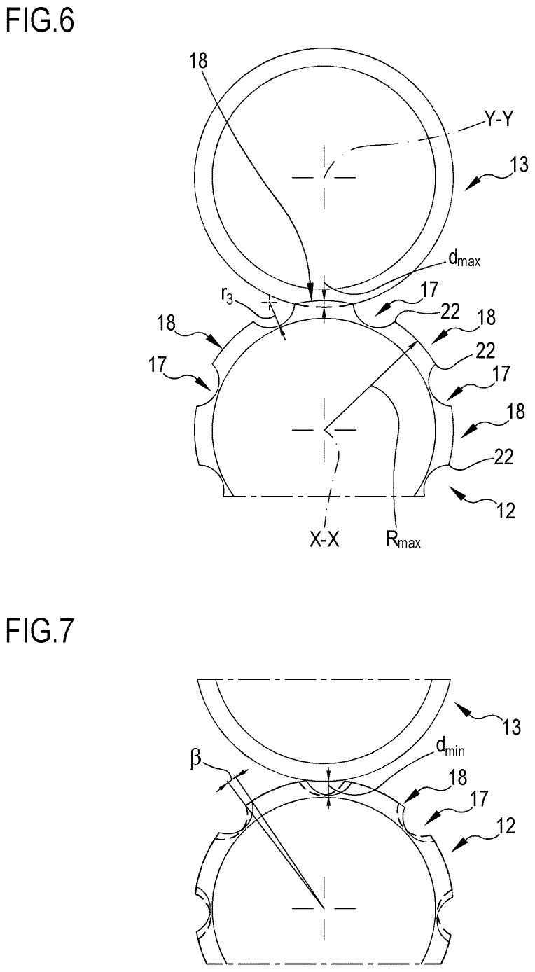

FIG. 6 is a side view of the elements of FIG. 5;

FIG. 7 is another side view of the elements of FIG. 5;

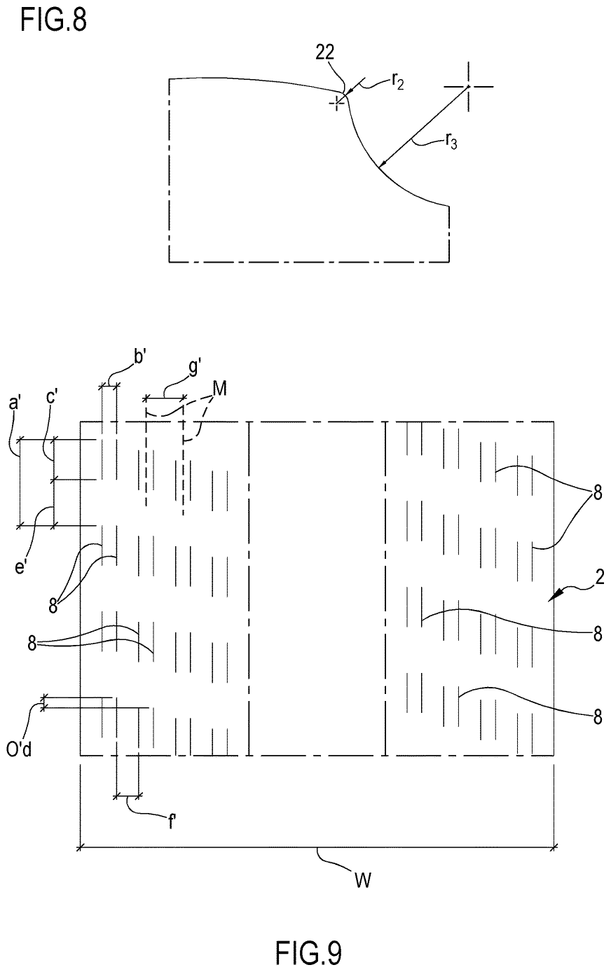

FIG. 8 shows a detail of one of the elements of FIG. 6;

FIG. 9 shows the sheet of aerosol-generating substrate processed by the device of the preceding figures and according to a method for weakening a sheet of aerosol-generating substrate;

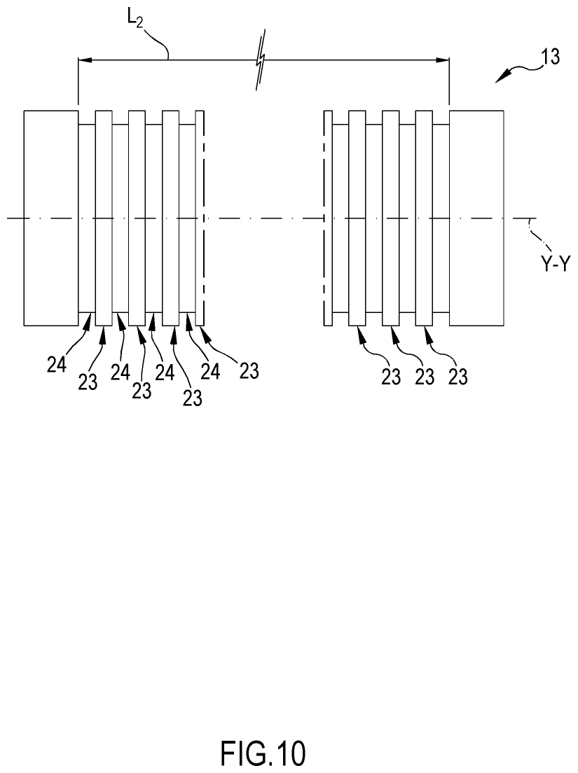

FIG. 10 shows one of the elements of FIG. 5;

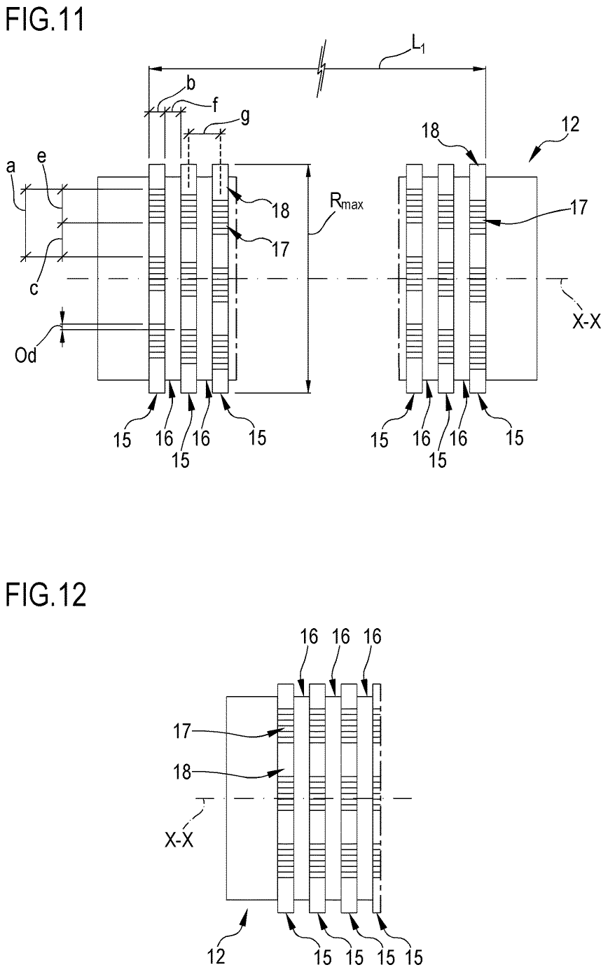

FIG. 11 shows another of the elements of FIG. 5;

FIG. 12 shows a variant embodiment of the element of FIG. 11;

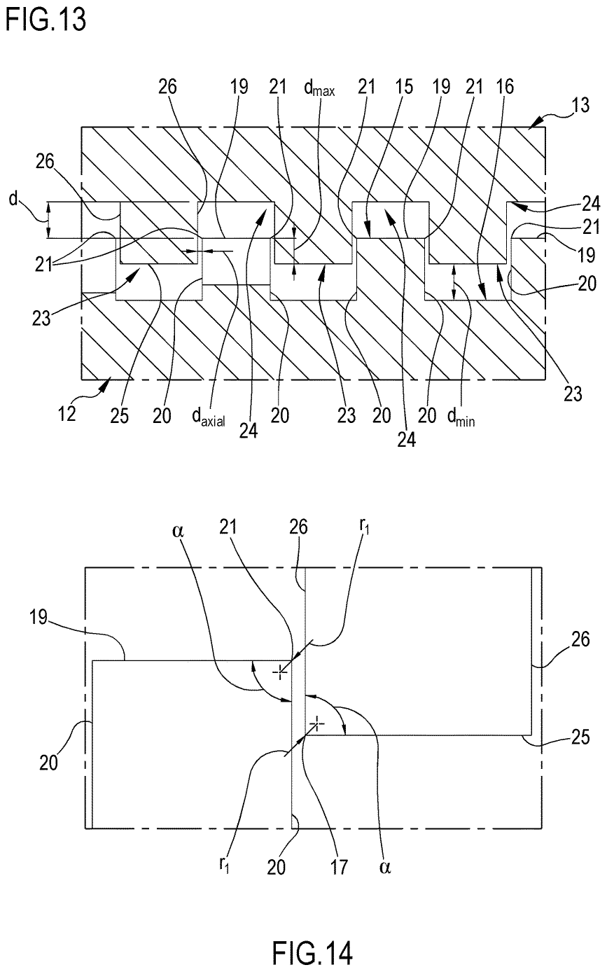

FIG. 13 is an enlarged part of the element of FIG. 11; and

FIG. 14 shows a detail of FIG. 13;

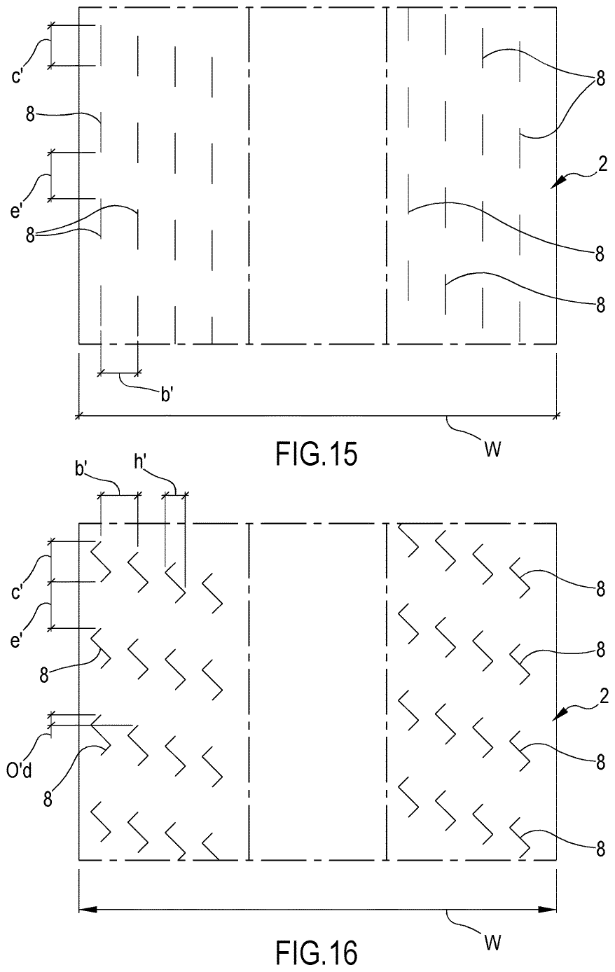

FIGS. 15 and 16 show other sheets of aerosol-generating substrate processed by a device and through a method according to the invention.

The device 1 shown in FIGS. 1 and 2 is configured for weakening a sheet 2 of aerosol-generating substrate for an aerosol-generating article component 3. The device 1 is part of an apparatus for manufacturing aerosol-generating article components 3 and the apparatus is partially represented in FIGS. 1 and 2.

An aerosol-generating article usually comprises an aerosol-generating article component 3 comprising the aerosol-generating substrate and a filter with a mouthpiece end.

In the aerosol-generating articles, the aerosol is generated by the transfer of heat from a heat source to the physically separate aerosol-generating substrate, which may be located in contact with, within, around, or downstream of the heat source. During use of the aerosol-generating article, the volatile compounds are released from the aerosol-generating substrate by heat transfer from the heat source and are entrained in air drawn through the aerosol-generating article.

The aerosol-generating article component 3 is realized by manufacturing the sheet 2 of aerosol-generating substrate, weakening the sheet 2 of aerosol-generating substrate as will be explained further on, gathering the sheet 2 of aerosol-generating substrate to form a continuous rod and cutting the continuous rod into a plurality of aerosol-generating article components 3 each having a rod shape. The weakening process is helpful for folding and gathering the sheet 2 of aerosol-generating substrate into the rods that will fit into the aerosol generating articles. The aerosol-generating article component 3 comprises therefore a gathered weakened sheet formed from a cut portion of the weakened sheet 2 of aerosol-generating substrate.

The sheet 2 of aerosol-generating substrate may be realized by preparing a slurry with a powder and a binder, along with possible other ingredients, and by casting the slurry onto a surface, for instance a moving metal belt, to produce the sheet 2 of aerosol-generating substrate. The sheet 2 of aerosol-generating substrate may comprise fibers, vegetable and/or alkaloid particles, a binder and an aerosol forming agent. The vegetable and/or alkaloid particles may comprise tobacco and/or nicotine and/or botanicals and/or cellulose powder. The sheet 2 of aerosol-generating substrate may be a tobacco-containing substrate or an herbaceous or plant-based cast sheet, for instance tobacco-free, or a plastic fiber-based material or a biodegradable fiber-based material, for instance cotton or cellulose. The sheet 2 of aerosol-generating substrate may contain an alkaloid, such as nicotine.

For instance, one example of aerosol-generating substrate comprises tobacco, glycerine, cellulose fibers, carboxymethylcellulose (CMC), graphite. Another example comprises botanicals, cellulose powder, cellulose fibers, carboxymethylcellulose (CMC), glycerine.

The apparatus for manufacturing aerosol-generating article components 3 comprises a reel holder 4 carrying the sheet 2 of aerosol-generating substrate for an aerosol-generating article component. The sheet 2 of aerosol-generating substrate, previously manufactured, is coiled in a bobbin 5 installed on the reel holder 4. The sheet 2 of aerosol-generating substrate unwound from the bobbin 5 is fed along a feeding path in a feeding direction “F”.

Downstream of the reel holder 4, with respect to the feeding direction “F”, the apparatus comprises an upper lamination roller 6 and lower lamination roller 7. The upper lamination roller 6 and lower lamination roller 7 rotate about respective two parallel axis.

Peripheral surfaces of the upper lamination roller 6 and lower lamination roller 7 are placed close each other to delimit a gap. The sheet 2 of aerosol-generating substrate unwound from the bobbin 5 passes through said gap where the upper lamination roller 6 and lower lamination roller 7 are configured to compact the sheet 2, to decrease its thickness and to smoothen the surfaces of sheet 2 in order to ensure that its thickness remains symmetric during and after the following steps. The upper lamination roller 6 and the lower lamination roller 7 perform a lamination step.

Upstream of the upper lamination roller 6 and lower lamination roller 7, the sheet 2 of aerosol-generating substrate may have an average thickness “t” between 0.15 mm and 0.35 mm. As a result of the lamination step, the average thickness “t” of the sheet 2 may be decreased to about 0.18 mm-0.26 mm.

Downstream of the upper lamination roller 6 and lower lamination roller 7, with respect to the feeding direction “F”, the apparatus comprises the device 1 for weakening the sheet 2 of aerosol-generating substrate. The device 1 is configured for making a plurality of longitudinal through cuts 8 in the sheet 2 of aerosol-generating substrate in order to define longitudinal folding lines to facilitate folding and gathering of the sheet 2 of aerosol-generating substrate to form a rod 9 (FIGS. 1 and 2). Features of the through cuts 8 will be discussed later in the present description. The rod 9 may be wrapped in a wrapper 10 and cut in a plurality of aerosol-generating article components 3 (FIGS. 3 and 4).

FIGS. 1 and 2 show schematically a folding device 11 placed downstream of the device 1 for weakening the sheet 2 of aerosol-generating substrate and configured to move the sheet 2 from a flat configuration (upstream of the folding device 11) to a gathered rod-shaped configuration (downstream of the folding device 11) and to wrap the wrapper around the gathered sheet 2. The folding device 11 may be shaped like a tapered funnel.

The device 1 for weakening the sheet 2 of aerosol-generating substrate comprises a first roller 12 configured to rotate about a first rotation axis “X-X” and a second roller 13 configured to rotate about a second rotation axis “Y-Y”. The first roller 12 and the second roller 13 are mounted on a frame 14 (schematically represented in FIG. 1) such that they are allowed to rotate about the respective first rotation axis “X-X” and second rotation axis “Y-Y” and are operationally connected to a motor, not shown, configured to rotate them about said first and second rotation axes “X-X”, “Y-Y”.

As depicted in dashed lines in FIGS. 1 and 2, the upper lamination roller 6 and the lower lamination roller 7 may be placed just upstream and/or downstream of the first roller 12 and second roller 13 of the device 1 and may be mounted on the same frame 14.

The first roller 12 comprises a plurality of first circumferential ridges 15 provided on a first radial outer face of said first roller 12 and delimiting a respective plurality of first circumferential grooves 16 on the first radial outer face (FIGS. 5, 11, 12, 13).

The radial outer face of the first roller 12 has a cylindrical shape and each of the first circumferential ridges 15 is shaped like a circular ring that surrounds the radial outer face and protrudes radially from said radial outer face. Each first circumferential groove 16 is annular and is delimited between two first circumferential ridges 15. The first rotation axis “X-X” passes through a centre of each first circumferential ridge 15 and each first circumferential groove 16.

Each first circumferential ridge 15 comprises a plurality of relief recesses 17 circumferentially spaced from each other along said first circumferential ridge and a plurality of elevations 18 are delimited between the relief recesses 17. As better shown in FIGS. 6 and 7, each relief recess 17 is spaced from another relief recess 17 by one elevation 18. A top portion 19 of each elevation 18 defines a portion of the radially outermost surface of the first roller 12 and is shaped like an arch of circumference having a maximum radius “Rmax” and having its centre in the first rotation axis “X-X”. Each relief recess 17 is delimited by an arch-shaped concave surface having a radius “r3”. For instance, the arch-shaped concave surface is a half-circle.

The plurality of elevations 18 and relief recesses 17 of each first circumferential ridge 15 are arranged around the first rotation axis “X-X” according to a pitch “a” which is a circumferential distance between two sequential relief recesses 17 or two sequential elevations 18. Each elevations 18 has a circumferential amplitude “c” and each relief recesses 17 has a circumferential amplitude “e”. Each first circumferential ridge 15 has an axial width “b” and each first circumferential groove 16 has an axial width “f” (FIG. 11).

In a cross section including the first rotation axis “X-X” (see FIGS. 13 and 14), each first circumferential ridge 15 has a rectangular outline. The cross section of each first circumferential ridge 15 is delimited by the mentioned top portion 19 and by two opposed side faces 20. The side faces 20 protrude from respective first circumferential grooves 16 and the top portion 20 connects distal ends of the side faces 20. The side faces 20 are parallel to each other. Each side face 20 and the top portion 19 delimit an angle “a” of 90 degrees and define a sharp edge 21. The sharpness of the sharp edges 21 is determined by the edge radius “r1” of the sharp edge 21 at its apex.

As better shown in FIGS. 6, 7 and 8, the arch-shaped concave surface and two respective adjoining elevations 18 delimit two auxiliary edges 22 which are parallel to the first rotation axis “X-X”. Differently from the sharp edges 21, each auxiliary edge 22 is rounded or dull. The dullness of the auxiliary edge 22 is determined by the edge radius “r2” of said auxiliary edge 22 at its apex.

The second roller 13 comprises a plurality of second circumferential ridges 23 provided on a second radial outer face of said second roller 13 and delimiting a respective plurality of second circumferential grooves 24 on the second radial outer face (FIGS. 5, 10, 13).

The radial outer face of the second roller 13 has a cylindrical shape and each of the second circumferential ridges 23 is shaped like a circular ring that surrounds the radial outer face and protrudes radially from said radial outer face. Each second circumferential groove 24 is annular and is delimited between two second circumferential ridges 23. The second rotation axis “Y-Y” passes through a centre of each second circumferential ridge 23 and each second circumferential groove 24.

Differently from the first circumferential ridges 15 of the first roller 12, a top portion 25 of each second circumferential ridge 23 of the second roller 13 is continuous and devoid of relief recesses. As better shown in FIGS. 5, 6, 7 and 10, the top portion 25 of each second circumferential ridge 23 defines a portion of the radially outermost surface of the second roller 12 and is shaped like a circumference having its centre in the second rotation axis “Y-Y”. The maximum radius of the top portions 25 of the second circumferential ridges 23 may be equal to the maximum radius “Rmax” of the top portions 19 the elevations 18 cited above.

In a cross section including the second rotation axis “Y-Y” (see FIGS. 10, 13 and 14) each second circumferential ridge 23 has a rectangular outline. The cross section of each second circumferential ridge 23 is delimited by the mentioned top portion 25 and by two opposed side faces 26. The side faces 26 protrude from respective second circumferential grooves 24 and the top portion 25 connects distal ends of the side faces 26. The side faces 26 are parallel to each other. Each side face 26 and the top portion 25 delimit an angle “α” of 90 degrees and define a sharp edge 27. The sharpness of the sharp edges 27 is determined by the edge radius “r1” of the sharp edge 27 at its apex.

As better shown in FIGS. 5 and 13, the first rotation axis “X-X” and the second rotation axis “Y-Y” are parallel to each other and the first roller 12 and the second roller 13 are intermeshing at a coupling zone, i.e. the elevations 18 of the first circumferential ridges 15 of the first roller 12 are inserted in the second circumferential grooves 24 of the second roller 13 and the second circumferential ridges 23 of the second roller 13 are inserted in the first circumferential grooves 16 of the first roller 12. The coupling zone is a zone located astride or at a plane containing both the first rotation axis “X-X” and the second rotation axis “Y-Y”.

The relative position and dimensions of the first roller 12 and second roller 13 are such that, when an elevation 18 of one of the first circumferential ridges 15 is located at the coupling zone, said elevation 18 is partially positioned in the respective second circumferential groove 24 as in FIGS. 6 and 13. In this position, the top portion 19 of the elevation 18 and the top portion 25 of the second circumferential ridge 23 are spaced of a maximum radial distance “dmax” measured in the plane containing both the first rotation axis “X-X” and the second rotation axis “Y-Y” (FIGS. 6 and 13). Furthermore, said elevation 18 of the first circumferential ridge 15 is axially spaced from two adjacent second circumferential ridges 23 of the second roller 13 of a minimum axial distance “daxial”, i.e. the first circumferential ridges 15 and the second circumferential ridges 23 do not swipe against each other.

The relative position and dimensions of the first roller 12 and second roller 13 are such that, when a relief recess 17 of one of the first circumferential ridges 15 is located at the coupling zone, said relief recess 17 is radially spaced from the respective second circumferential groove 24 and the first circumferential ridges 15 lies outside said second circumferential groove 24 as in FIG. 7. In this position, a bottom portion of the relief recess 17 of the first roller 12 and the top portion 25 of the second circumferential ridge 23 of the second roller 13 are spaced of a minimum radial distance “dmin” measured in the plane containing both the first rotation axis “X-X” and the second rotation axis “Y-Y” (FIGS. 7 and 13).

The relative position and dimensions of the first roller 12 and second roller 13 are such that, at the coupling zone of the first roller 12 with the second roller 13, the elevations of the first circumferential ridges 15 are spaced from bottoms of the second circumferential grooves 24 of a further radial distance “d” (FIG. 13).

In the non-limiting example of the Figures, the relief recesses 17 of one first circumferential ridge 15 are circumferentially offset with respect to the relief recesses 17 of two first circumferential ridges 15 contiguous to the one first circumferential ridge 15. Moving along the first rotation axis “X-X” in one direction (for instance form left to right looking at FIG. 5, 11 or 12), the relief recesses 17 of each first circumferential ridge 15 are circumferentially offset with respect to a preceding first circumferential ridge 15 always in a same direction (clockwise or counter-clockwise) of an offset distance “Od” corresponding to an angular offset “B” (FIG. 7).

In the variant embodiment of FIG. 12 the relief recesses 17 and the elevations 18 of the first circumferential ridges 15 are all axially aligned, i.e. the offset distance “Od” and the angular offset “B” are null.

The first roller 12 has a first axial length “L1” measured parallel to the first rotation axis “X-X” and between the two first circumferential ridges 15 placed at opposite ends of the first roller 12 (FIG. 11). The second roller 13 has a second axial length “L2” measured parallel to the second rotation axis “Y-Y” and between the two second circumferential grooves 24 placed at opposite ends of the second roller 13 (FIG. 11).

The first axial length “L1” and second axial length “L2” may be designed as a function of a width “w” of the sheet 2 of aerosol-generating substrate. The first axial length “L1” and second axial length “L2” may be less than the width “w” to avoid cutting longitudinal edges of the sheet 2. For instance, the first axial length “L1” is equal to the second axial length “L2” and equal to 80 percent-90 percent of the width “w” of the sheet 2.

The first roller 12 may be manufactured by producing and then assembling a plurality of first disks and a plurality of second disks, wherein the first disks and the second disks are stacked and arranged in alternating manner. The first disks comprise the first circumferential ridges 15 and the second disks define bottoms of the first circumferential grooves 16.

The second roller 13 may be manufactured by producing and then assembling a plurality of third disks and a plurality of fourth disks, wherein the third disks and the fourth disks are stacked and arranged in alternating manner. The third disks comprise the second circumferential ridges and the fourth disks define bottoms of the second circumferential grooves.

Other manufacturing processes may be employed. For instance, the first and the second roller 12, 13 may be each manufactured by machining from respective solid bodies.

The sheet 2 of aerosol-generating substrate is weakened by passing said sheet 2 of aerosol-generating substrate between the first roller 12 and the second roller 13 while the first roller 12 and the second roller 13 rotate in opposite directions.

The sharp edges 21 of the elevations 18 of the first circumferential ridges 15 and the sharp edges 27 of the second circumferential ridges 23 generate the through cuts 8 in the sheet 2 of aerosol-generating substrate only when the elevations 18 of the first circumferential ridges 15 are located at the coupling zone. The rounded auxiliary edges 22 do not cut the sheet 2 along lines transversal to the cuts where the sheet 2 touches said auxiliary edges 22.

When the relief recesses 17 of the first circumferential ridges 15 are located at the coupling zone, the sharp edges 21 of the elevations 18 of the first circumferential ridges 15 and the sharp edges 27 of the second circumferential ridges 23 do not cut the sheet 2.

The offset through cuts 8 made by the first and second roller 12, 13 of FIG. 5 are shown in FIG. 9.

The variant embodiment of FIG. 12 allows to generate groups of cuts 8 aligned along directions transversal to the feeding direction “F” of the sheet 2 of aerosol-generating substrate.

In all the embodiments, the through cuts 8 work as weakened segments or folding lines of the sheet 2 of aerosol-generating substrate, which help bending of the sheet 2 at said segments or lines performed in the following folding and gathering step by the folding device 11.

All the sizes provided above allow to generate the through cuts 8 without compressing and damaging the sheet 2 and may be designed as function of a thickness “t” and/or of a width “w” of the sheet 2 of aerosol-generating substrate.

Furthermore, the first roller 12 and the second roller 13 may be rotated with a peripheral speed between 60 m/s and 500 m/s in order to move the sheet 2 of aerosol-generating substrate between the first roller 12 and the second roller 13 with a linear speed between 60 m/s and 500 m/s.

The following Tables 1 and 2 show possible dimensions of the first roller 12 and second roller 13, which dimensions are graphically represented in FIGS. 6, 7, 8, 11, 13 and 14.

TABLE 1

| a | pitch of the relief recesses | 5.0-20.0 | mm |
|---|---|---|---|
| b | axial width of the first circumferential ridges | 1-15 | mm |
| c | circumferential amplitude of the elevations | 0.1-2.0 | mm |
| d | further radial distance | 0.5-2 | mm |
| dmin | minimum radial distance | 0.5-2 | mm |
| dmax | maximum radial distance | 0.2-1.5 | mm |
| daxial | minimum axial distance | 0.02-0.06 | mm |
| e | circumferential amplitude of the relief recesses | 5-20 | mm |
| f | axial width of the first circumferential grooves | 1-2 | mm |
| Od | offset distance between the relief recesses | 0-20 | mm |
| t | thickness of the sheet | 0.15-0.35 | mm |
| W | width of the sheet | 80-180 | mm |
| α | angle of the sharp edges | 90 | degrees |
| β | angular offset between the relief recesses | 0 degrees-30 degrees | |
| r1 | radius of the sharp edges | 0.03-0.05 | mm |
| r3 | radius of the concave surfaces | 5-15 | mm |
| Rmax | maximum radius of the elevations | 40-300 | mm |
| L1 | first axial length | 200-300 | mm |
| L2 | second axial length | 200-300 | mm |

TABLE 2

| | |
|---|---|
| dmin/Rmax | 0.03-0.005 |
| dmin/t | 1.5-3.5 |
| daxial/Rmax | 0.0002-0.0005 |
| daxial/t | 0.2-0.3 |

The following Table 3 shows further possible dimensions of the first roller 12.

TABLE 3

| | | | | Ex. 1 | | Ex. 2 | |
|---|---|---|---|---|---|---|---|
| a | pitch of the relief recesses | 0.2-16.0 | mm | 10 | mm | 7 | mm |
| b | axial width of the first circumferential ridges | 1-15 | mm | 3 | mm | 2 | mm |
| c | circumferential amplitude of the elevations | 0.1-8.0 | mm | 6 | mm | 4 | mm |
| e | circumferential amplitude of the relief recesses | 0.1-8.0 | mm | 4 | mm | 3 | mm |
| f | axial width of the first circumferential grooves | 2-4 | mm | 2 | mm | 2 | mm |
| g | axial distance between median lines | 2-6 | mm | 5 | mm | 4 | mm |

| | | | | | | |
|---|---|---|---|---|---|---|
| Od | offset distance between the relief recesses | 20%-40% c | 1.2 | mm | 0.8 | mm |

The following Table 4 shows possible dimensions of the cuts 8 of the sheet 2 (shown in FIG. 9) made through the first roller 12 provided with the features of Table 3.

The cuts 8 are arranged in pairs and each pair comprises two parallel cuts 8. Each cut 8 is a straight line parallel to the feeding direction of the sheet 2 of aerosol-generating substrate. Pairs of cuts 8 are aligned along longitudinal paths and the pairs of cuts 8 of one path are offset with respect to the pairs of cuts 8 of an adjacent path.

TABLE 4

| | Range | | Ex. 1 | | Ex. 2 | |
|---|---|---|---|---|---|---|
| a′ - pitch = c′ + e′ | 0.2-16 | mm | 10 | mm | 7 | mm |
| b′ - transverse distance | 1-15 | mm | 3 | mm | 2 | mm |
| c′ - length | 0.1-8 | mm | 6 | mm | 4 | mm |
| e′ - longitudinal distance | 0.1-8 | mm | 4 | mm | 3 | mm |
| f′ - transverse distance between | 2-4 | mm | 2 | mm | 2 | mm |
| pairs | | | | | | |
| g′ - transverse distance between | 2-6 | mm | 5 | mm | 4 | mm |
| median lines “M” | | | | | | |

| | | | | | |
|---|---|---|---|---|---|
| O′d - offset longitudinal distance | 20%-40% c′ | 1.2 | mm | 0.8 | mm |

FIG. 15 shows a further example of a sheet of aerosol-generating substrate processed by a device and through a method according to the invention. The cuts 8 are single straight cuts aligned along respective paths and offset with respect to the cuts 8 of an adjacent path. Example measures of these single straight cuts are in the following Table 5.

TABLE 5

| | Example | |
|---|---|---|
| a′ - pitch = c′ + e′ | 6 | mm |
| b′ - transverse distance | 5 | mm |
| c′ - length | 4 | mm |
| e′ - longitudinal distance | 2 | mm |
| O′d - offset longitudinal distance | 0.8 | mm |

FIG. 16 shows another example of a sheet of aerosol-generating substrate processed by a device and through a method according to the invention. The cuts 8 are single zig-zag cuts aligned along respective paths and offset with respect to the cuts 8 of an adjacent path. Example measures of these single zig-zag cuts are in the following Table 6.

TABLE 6

| | Example | |
|---|---|---|
| a′ - pitch = c′ + e′ | 6 | mm |
| b′ - transverse distance | 5 | mm |
| c′ - length | 4 | mm |
| e′ - longitudinal distance | 2 | mm |
| h′ - transverse size | 1.5 | mm |
| O′d - offset longitudinal distance | 0.8 | mm |

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5 percent of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A device for weakening a sheet of aerosol-generating substrate for an aerosol-generating article component, the device comprising:
a first roller having a first rotation axis and comprising a plurality of first circumferential ridges provided on a first radial outer face of the first roller, the plurality of first circumferential ridges delimiting a respective plurality of first circumferential grooves on the first radial outer face; and
a second roller having a second rotation axis and comprising a plurality of second circumferential ridges provided on a second radial outer face of the second roller, the plurality of second circumferential ridges delimiting a respective plurality of second circumferential grooves on the second radial outer face,
wherein each first circumferential ridge comprises a plurality of relief recesses circumferentially spaced from each other along the first circumferential ridge, a plurality of elevations being delimited between the relief recesses,
wherein, at a coupling zone of the first roller with the second roller, the plurality of elevations of the first circumferential ridges are inserted in the second circumferential grooves,
wherein, in a cross section including the first rotation axis, each first circumferential ridge has a rectangular outline,
wherein, in a cross section including the second rotation axis, each second circumferential ridge has a rectangular outline,
wherein the rectangular outlines of the first circumferential ridge and of the second circumferential ridge have sharp edges configured to generate cuts in a sheet of aerosol-generating substrate passing between the first roller and the second roller, the cuts creating weakened folding lines facilitating folding and gathering of the sheet of aerosol-generating substrate to form a rod, and
wherein a circumferential amplitude of the elevations is between 0.1 mm and 8.0 mm.

17. The device according to claim 16, wherein the circumferential amplitude of the elevations is between 0.1 mm and 2.0 mm.

18. The device according to claim 16, wherein a pitch of the relief recesses is between 5.0 mm and 20.0 mm.

19. The device according to claim 16, wherein each of the sharp edges has an angle of 90 degrees.

20. The device according to claim 16, wherein each of the sharp edges has a radius equal to or less than 0.05 mm.

21. The device according to claim 16, wherein a ratio of a minimum radial distance between a bottom portion of the relief recesses of the first roller and a top portion of the second circumferential ridges of the second roller to a thickness of the sheet of aerosol-generating substrate is equal to or greater than 1.5.

22. The device according to claim 16, wherein a ratio of a minimum axial distance between a first circumferential ridge of the first roller and an adjacent second circumferential ridge of the second roller to a thickness of the sheet of aerosol-generating substrate is between 0.2 and 0.3.

23. The device according to claim 16,
wherein each relief recess is delimited by a concave surface,
wherein each concave surface and two respective adjoining elevations delimit two auxiliary edges parallel to the first rotation axis, and
wherein each of the two auxiliary edges is rounded.

24. The device according to claim 16, wherein the relief recesses of one first circumferential ridge are circumferentially offset with respect to the relief recesses of another first circumferential ridge to generate offset cuts.

25. The device according to claim 16, wherein a top portion of each second circumferential ridge is continuous and devoid of relief recesses.

26. A method for weakening a sheet of aerosol-generating substrate for an aerosol-generating article component, the method comprising:
making cuts in the sheet of aerosol-generating substrate by passing the sheet of aerosol-generating substrate between the first roller and the second roller of the device according to claim 16 while the first roller and the second roller rotate in opposite directions, the cuts creating weakened folding lines facilitating folding and gathering of the sheet of aerosol-generating substrate to form a rod.

27. The method according to claim 26, wherein the cuts are through-cuts.

28. The method according to claim 26,
wherein the sheet of aerosol-generating substrate is a herbaceous or plant-based cast sheet, or
wherein the sheet of aerosol-generating substrate is a fiber-based material.

29. The method according to claim 26, wherein the sheet of aerosol-generating substrate has a thickness comprised between 0.15 and 0.35.

30. A process for manufacturing an aerosol-generating article component, the process comprising the following steps:
manufacturing a sheet of aerosol-generating substrate;
weakening the sheet of aerosol-generating substrate according to the method of claim 26;
gathering the sheet of aerosol-generating substrate to form a continuous rod; and
cutting the continuous rod into a plurality of aerosol-generating article components each having a rod shape, each aerosol-generating article component comprising a gathered weakened sheet formed from a cut portion of the weakened sheet of aerosol-generating substrate.
